(19) United States
(12) Patent Application Publication
(10) Pub. No.: US 2009/0179847 A1
(43) Pub. Date: Jul. 16, 2009

(54) LIQUID CRYSTAL DISPLAY APPARATUS

(76) Inventors: Kenji HARADA, Nomi-shi (JP); Takanori TSUNASHIMA, Fukaya-shi (JP); Hiroyuki KIMURA, Fukaya-shi (JP); Koji SHIGEHIRO, Kumagaya-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/342,751

(22) Filed: Dec. 23, 2008

(30) Foreign Application Priority Data
Jan. 11, 2008 (JP) 2008-004541

(51) Int. Cl. G09G 3/36

(52) U.S. Cl. 345/98; 345/87

(57) ABSTRACT

A liquid crystal display apparatus includes a plurality of source lines and gate lines, pixel switching elements, and a plurality of drive circuits, each provided for a group of a predetermined number of source lines, and converting i-bit data video signal into an analog gradation signal and supplying the analog gradation signal to each of the source lines, the liquid crystal display apparatus performing gradation display with an ith power of 2, based on i-bit data, wherein the drive circuits each include a first switching circuit which selects the video signal, a digital to analog conversion circuit DAC which converts the video signal into the gradation signal, a second switching circuit which supplies the gradation signal to each source line, and a control circuit which controls an order of supplying the gradation signal to each source line to be different every n horizontal period and every m vertical period.

### CROSS-REFERENCE TO RELATED APPLICATIONS

This application is based upon and claims the benefit of priority from prior Japanese Patent Application No. 2008-004541, filed Jan. 11, 2008, the entire contents of which are incorporated herein by reference.

### BACKGROUND OF THE INVENTION

1. Field of the Invention

The present invention relates to a liquid crystal display apparatus and more particularly to a liquid crystal display apparatus capable of preventing the occurrence of vertical streaks, non-uniformity, etc., caused by a voltage drop occurring in a gradation voltage generating circuit, even when multiplexer drive of source lines and DACs are used in combination.

2. Description of the Related Art

In recent years, development of “built-in drive circuit type” TFT-LCDs in which a scanning line drive circuit and a video signal line drive circuit are integrally and simultaneously formed with pixel TFTs on a transparent insulating substrate has been actively carried out. According to this configuration, the effective screen area of the transparent insulating substrate of the liquid crystal display apparatus can be increased and the manufacturing cost can be reduced.

FIG. 17 is a diagram showing an example of a configuration of a built-in drive circuit type liquid crystal display apparatus.

The liquid crystal display apparatus includes a liquid crystal display panel LC and a drive circuit DD that drives and controls the liquid crystal display panel LC.

In the liquid crystal display apparatus, any of memories M21 to M24 is switched by a multiplexer MPX and connected to a digital to analog converter DAC. Furthermore, an output from the digital to analog converter DAC is outputted, by switchers S1 to S4, to a corresponding one of liquid crystal source lines corresponding to the memories M21 to M24.

In the liquid crystal display apparatus, instead of providing a digital to analog converter DAC to each data line, one digital to analog converter DAC is provided to a plurality of data lines and the digital to analog converter DAC is used in a time division manner.

By thus performing digital to analog conversion in a time division manner and further performing a write to source lines in a time division manner, the numbers of DAC circuits and AMP circuits can be reduced, and accordingly, a built-in drive circuit type TFT-LCD with low power consumption and a narrow frame is implemented (Jpn. Pat. Appln. KOKAI Publication No. 5-173506).

### BRIEF SUMMARY OF THE INVENTION

According to a first aspect of the present invention, there is provided a liquid crystal display apparatus comprising: a plurality of source lines and a plurality of gate lines configured to be orthogonal to one another; pixel switching elements configured to be respectively provided at intersections of the source lines and the gate lines; and a plurality of drive circuits configured to be each provided for a group of a predetermined number of source lines, and convert i (an integer greater than or equal to two)-bit data video signal into an analog gradation signal and supply the analog gradation signal to each of the source lines, the liquid crystal display apparatus performing gradation display with an ith power of 2, based on i-bit data, wherein the drive circuits each include:

a first switching circuit which selects the video signal in a time division manner; a digital to analog conversion circuit which converts a selected portion of the video signal into the gradation signal; a second switching circuit which supplies the gradation signal to each source line in a time division manner; and a control circuit which controls an order of supplying, by the second switching circuit, the gradation signal to each source line to be different every n horizontal period and every m vertical period (n and m each are an integer greater than or equal to one).

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram schematically showing a circuit configuration of a liquid crystal display apparatus;

FIG. 2 is a diagram showing a configuration of a first switcher;

FIG. 3 is a diagram showing a configuration of a digital to analog converter;

FIG. 4 is a diagram showing a configuration of a second switcher;

FIG. 5A is a diagram showing a configuration of a signal selector;

FIG. 5B is a diagram showing a configuration of the signal selector;

FIG. 6 is a diagram showing control timing of conventional control signals;

FIG. 7 is a diagram showing time variation in potential at an amplifier input node for the case of performing green raster display;

FIG. 8 is a diagram showing a state in which differences in luminance are visually identified as vertical streaks;

FIG. 9 is a diagram showing control timing of control signals in a first embodiment of the present invention;

FIG. 10A is a diagram showing a state of green raster display;

FIG. 10B is a diagram showing a state of green raster display;

FIG. 11 is a diagram showing another configuration of the digital to analog converter;

FIG. 12A is a diagram showing a polarity signal generating circuit;

FIG. 12B is a diagram showing a time-chart for generating a polarity signal;

FIG. 13A is a diagram showing a circuit that latches data on a data bus line according to a sampling timing signal;

FIG. 13B is a diagram showing a circuit that latches data on the data bus line according to a sampling timing signal;

FIG. 13C is a diagram showing a circuit that latches data on the data bus line according to a sampling timing signal;

FIG. 14A is a diagram showing a circuit that latches data on the data bus line according to a sampling timing signal;

FIG. 14B is a diagram showing a circuit that latches data on the data bus line according to a sampling timing signal;

FIG. 15 is a time chart showing an operation of holding data on the data bus line;

FIG. 16 is a diagram describing a method of switching between groups of source lines driven by amplifier circuits; and

FIG. 17 is a diagram showing an example of a configuration of a built-in drive circuit type liquid crystal display apparatus.

### DETAILED DESCRIPTION OF THE INVENTION

### First Embodiment

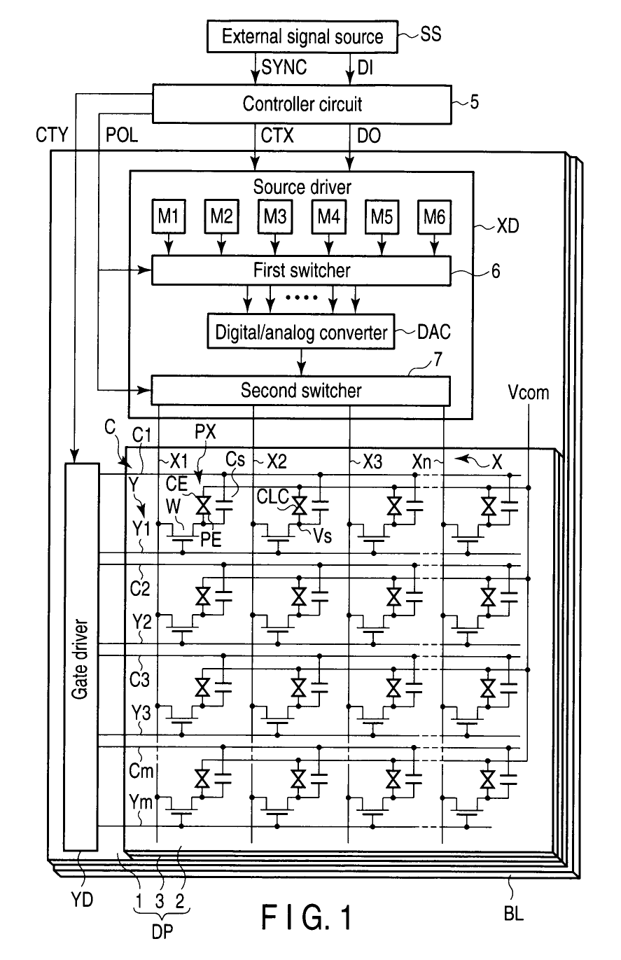

FIG. 1 is a diagram schematically showing a circuit configuration of a liquid crystal display apparatus. Note that in this drawing part of the liquid crystal display apparatus is simplified for easy understanding as a principle diagram.

The liquid crystal display apparatus includes a liquid crystal display panel DP and a display control circuit CNT that controls the liquid crystal display panel DP.

The liquid crystal display panel DP has a structure in which a liquid crystal layer 3 is held between an array substrate 1 and a counter-substrate 2 which are a pair of electrode substrates. The display control circuit CNT controls the transmittance of the liquid crystal display panel DP by a liquid crystal drive voltage applied to the liquid crystal layer 3 from the array substrate 1 and the counter-substrate 2.

In the array substrate 1, a plurality of pixel electrodes PEs are arranged in a substantially matrix form on a transparent insulating substrate. Also, a plurality of gate lines Y (Y1 to Ym) are arranged along the rows of the plurality of pixel electrodes PEs and a plurality of source lines X (X1 to Xn) are arranged along the columns of the plurality of pixel electrodes PEs.

A plurality of pixel switching elements Ws are respectively arranged near intersection locations of the gate lines Y and the source lines X. Each pixel switching element W is composed, for example, of a thin-film transistor having a gate connected to a corresponding gate line Y and having a source-drain path connected between a corresponding source line X and a corresponding pixel electrode PE, and conducts between the corresponding source line X and the corresponding pixel electrode PE when driven through the corresponding gate line Y.

The pixel electrodes PEs and a common electrode CE each are composed, for example, of a transparent electrode material such as an ITO. The pixel electrodes PEs and the common electrode CE each are covered with an alignment film AL and form a liquid crystal pixel PX, together with a pixel region which is part of the liquid crystal layer 3 and controlled to a liquid crystal molecular orientation according to an electric field from the pixel electrode PE and the common electrode CE.

Each of the plurality of liquid crystal pixels PXs has a liquid crystal capacitance CLC between a corresponding pixel electrode PE and the common electrode CE. A plurality of storage capacitance lines C1 to Cm each form storage capacitances Css which are capacitance-coupled to pixel electrodes PEs of liquid crystal pixels PXs in a corresponding row. The storage capacitances Css each have a sufficiently large capacitance value with respect to a parasitic capacitance of a pixel switching element W.

The display control circuit CNT has a gate driver YD, a source driver XD, and a controller circuit 5.

The gate driver YD sequentially drives the plurality of gate lines Y1 to Ym to bring the plurality of switching elements Ws into conduction on a row-by-row basis. The source driver XD outputs a pixel voltage Vs to each of the plurality of source lines X1 to Xn during a period in which the switching elements Ws in the respective rows are brought into conduction by drive of their corresponding gate lines Y. The controller circuit 5 controls the gate driver YD and the source driver XD.

The controller circuit 5 generates signals that control the operations of the respective units of the display control circuit CNT, based on a synchronizing signal SYNC inputted from an external signal source SS.

The controller circuit 5 generates a control signal CTY for the gate driver YD and a control signal CTX for the source driver XD, based on an inputted synchronizing signal SYNC.

The controller circuit 5 outputs, as pixel data DO, image data DI inputted from the external signal source SS to the plurality of pixels PXs, to the source driver XD at predetermined timing. The image data DI includes a plurality of pixel data units for the plurality of liquid crystal pixels PXs, and is updated every frame period (vertical scanning period V). The control signal CTY is supplied to the gate driver YD and the control signal CTX is supplied, together with the pixel data DO, to the source driver XD. The control signal CTY is used, as described above, to cause the gate driver YD to perform the operation of sequentially driving the plurality of gate lines Y. The control signal CTX is used to cause the source driver XD to perform the operation of assigning the pixel data units DO to the respective source lines X and specifying an output polarity.

The gate driver YD is composed using, for example, a shift register circuit to select a gate line Y.

The source driver XD converts each of the pixel data units DO into a pixel voltage Vs and outputs the pixel voltages Vs to the plurality of source lines X1 to Xn in a parallel manner.

A pixel voltage Vs is a voltage applied to a pixel electrode PE with reference to a common voltage Vcom of the common electrode CE, and is polarity-inverted relative to the common voltage Vcom to perform, for example, a frame-inversion drive scheme and a line-inversion drive scheme. A polarity signal POL for polarity inversion is inputted from the controller circuit 5 to the source driver XD.

The source driver XD includes memories M (M1 to M6), a first switcher 6, a digital to analog converter DAC, and a second switcher 7.

The memories M store data extracted from the pixel data DO inputted from the controller circuit 5 and provided for respective liquid crystal pixels PXs. The first switcher 6 switches between digital outputs from the memories M and outputs the digital outputs to the digital to analog converter DAC. The digital to analog converter DAC converts digital data into an analog gradation voltage. The digital to analog converter DAC sequentially charges, through the second switcher 7, a plurality of source lines (six source lines in the example of FIG. 1) to desired gradation voltages with one horizontal period being time-divided.

The first switcher 6 and the second switcher 7 switch between data units to be selected, by a polarity signal POL to be inputted thereto.

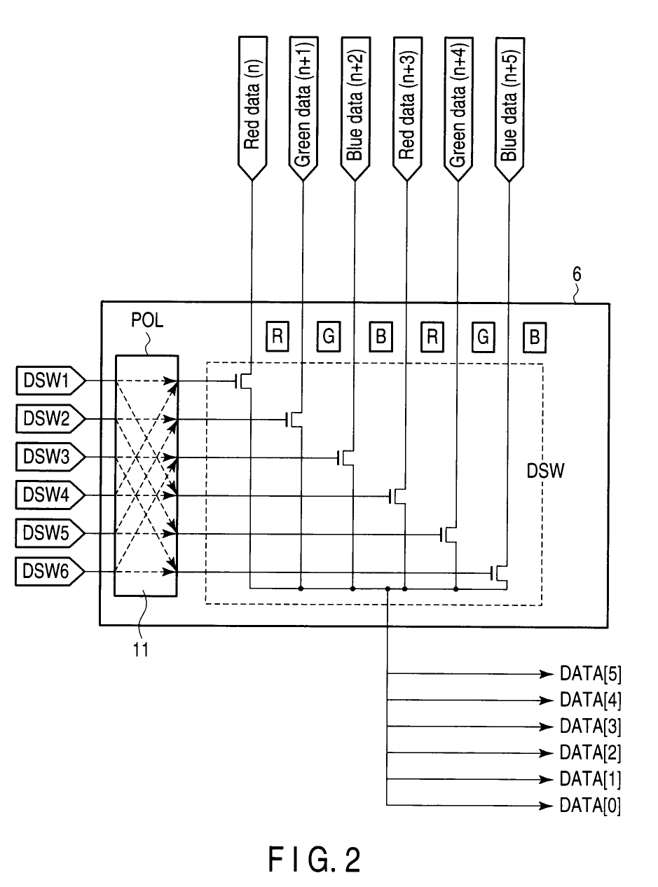

FIG. 2 is a diagram showing a configuration of the first switcher 6.

The first switcher 6 includes a signal selector 11 and a digital switch DSW. To the first switcher 6 are inputted pixel data DO having a resolving power of 6 bits (0 to 5) and provided for respective liquid crystal pixels PXs, from the memories M. Here, the pixel data DO includes, for example, six consecutive liquid crystal pixel data units (red data (n), green data (n+1), blue data (n+2), red data (n+3), green data (n+4), and blue data (n+5)).

Also, to the first switcher 6 are inputted control signals DSW1 to DSW 6. The control signals DSW1 to DSW6 are generated by a conversion circuit (not shown) converting a control signal CTX. The signal selector 11 brings any one of output lines into an on state, according to the control signals DSW1 to DSW6 which are sequentially and selectively inputted to be an on state and a polarity signal POL. The digital switch DSW turns on a switch connected to the output line having been brought into an on state and thereby selects a corresponding pixel data unit DO and outputs selected pixel data units DO as 6-bit data (DATA[0] to DATA[5]).

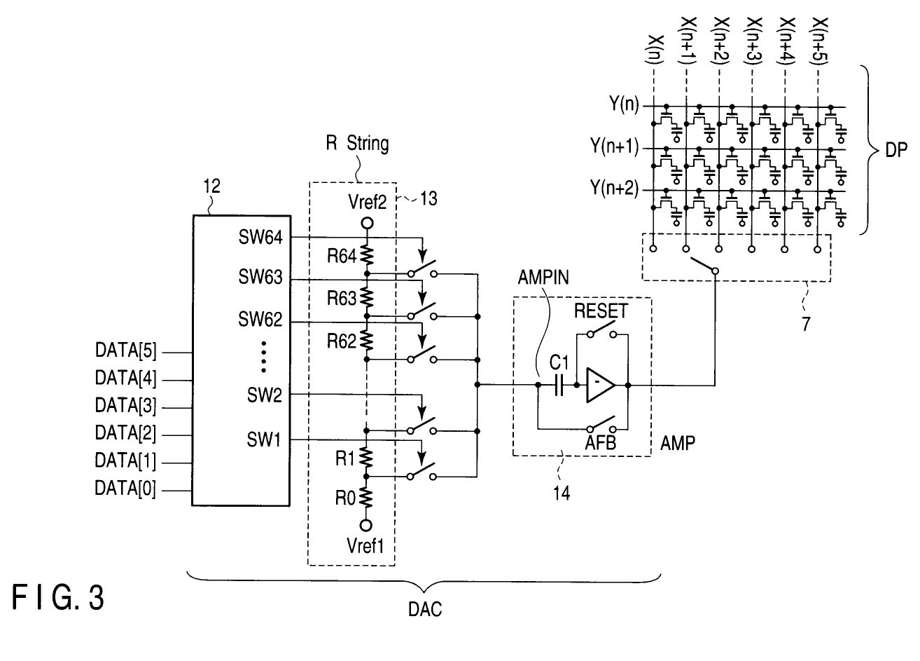

FIG. 3 is a diagram showing a configuration of the digital to analog converter DAC.

The digital to analog converter DAC includes a resistor DAC circuit 12, a gradation voltage generating unit 13 using a resistor string (denoted as R String in the drawing), and an amplifier circuit (denoted as AMP in the drawing) 14.

The 6-bit image signal digital data (DATA[0] to DATA[5]) are held in the resistor DAC circuit 12 and thereafter converted into gradation voltages that are generated by the resistor string in the gradation voltage generating unit 13. Then, a converted analog signal is inputted to the second switcher 7 through the amplifier circuit 14.

Now, the operation of the amplifier circuit 14 will be described.

When gradation voltages are generated using the resistor string, there is a problem that a voltage drop may occur due to the flowing of an output current. The amplifier circuit 14 operates such that an output voltage from the amplifier circuit 14 always matches an input voltage. Even when a current flows through a signal line, the amplifier circuit 14 operates such that the current is generated by the amplifier circuit 14. By this, the occurrence of a voltage drop can be prevented.

An amplifier input capacitance C1 connected to an input node AMPIN of the amplifier circuit 14 is charged to a threshold potential of an inverting amplifier in a RESET state in which a RESET signal is ON.

In an operating state, the RESET signal is OFF and the amplifier input capacitance C1 is charged to a potential equal to a gradation voltage outputted from the gradation voltage generating unit 13. Then, by an AFB signal, which is an amplifier output control signal, becoming ON, the AMP input and output are short-circuited, forming a feedback circuit. As a result, a potential equal to that of the input node AMPIN is outputted from the amplifier circuit 14.

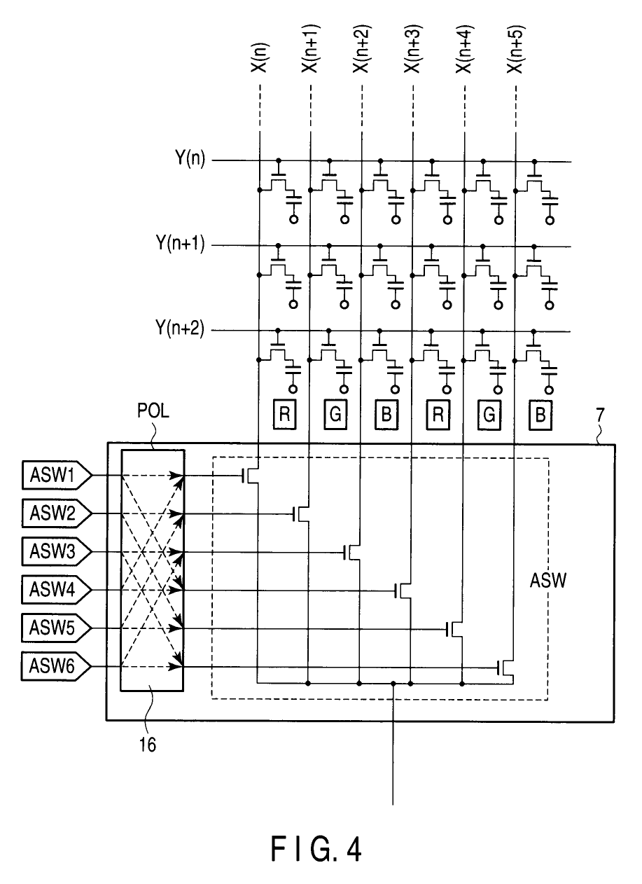

FIG. 4 is a diagram showing a configuration of the second switcher 7.

The second switcher 7 includes a signal selector 16 and an analog switch ASW. To the second switcher 7 are inputted gradation voltages provided for respective liquid crystal pixels PXs, from the digital to analog converter DAC in a time division manner.

Also, to the second switcher 7 are inputted control signals ASW1 to ASW 6. The control signals ASW1 to ASW6 are generated by a conversion circuit (not shown) converting a control signal CTX. The signal selector 16 brings any one of output lines into an on state, according to the control signals ASW1 to ASW6 which are sequentially and selectively inputted to be an on state and a polarity signal POL. The analog switch ASW turns on a switch connected to the output line having been brought into an on state and thereby outputs a gradation voltage to a corresponding signal line.

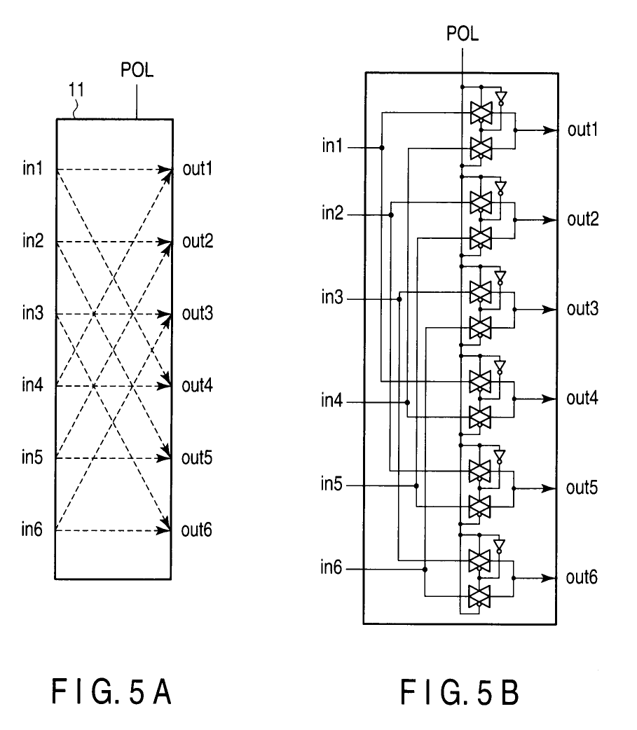

FIGS. 5A and 5B are diagrams showing the configuration of the signal selector 11. Note that since the signal selector 16 also has the same configuration as the signal selector 11, the signal selector 11 will be described.

FIG. 5A schematically shows a selection operation performed by the signal selector 11. Arrows extend from each of input units (in1 to in6) to two output units (out1 to out6), which indicates which output unit is to be selected is switched by a polarity signal POL.

For example, internal circuits are configured such that when the polarity signal POL is “H”, the input units in1, in2, in3, in4, in5, and in6 are respectively connected to the output units out1, out2, out3, out4, out5, and out6, and when the polarity signal POL is “L”, the input units in1, in2, in3, in4, in5, and in6 are respectively connected to the output units out4, out5, out6, out1, out2, and out3.

FIG. 5B is a block diagram of the signal selector 11.

A switch circuit is composed of an NMOS transistor and a PMOS transistor which are connected in parallel with each other. This configuration is employed because it provides a more stable operation than a configuration in which a switch circuit is composed of a single transistor. By a polarity signal POL, output circuits are switched.

Now, a drive operation of the source driver XD will be described.

First, a cause of vertical streaks in conventional driving methods will be described.

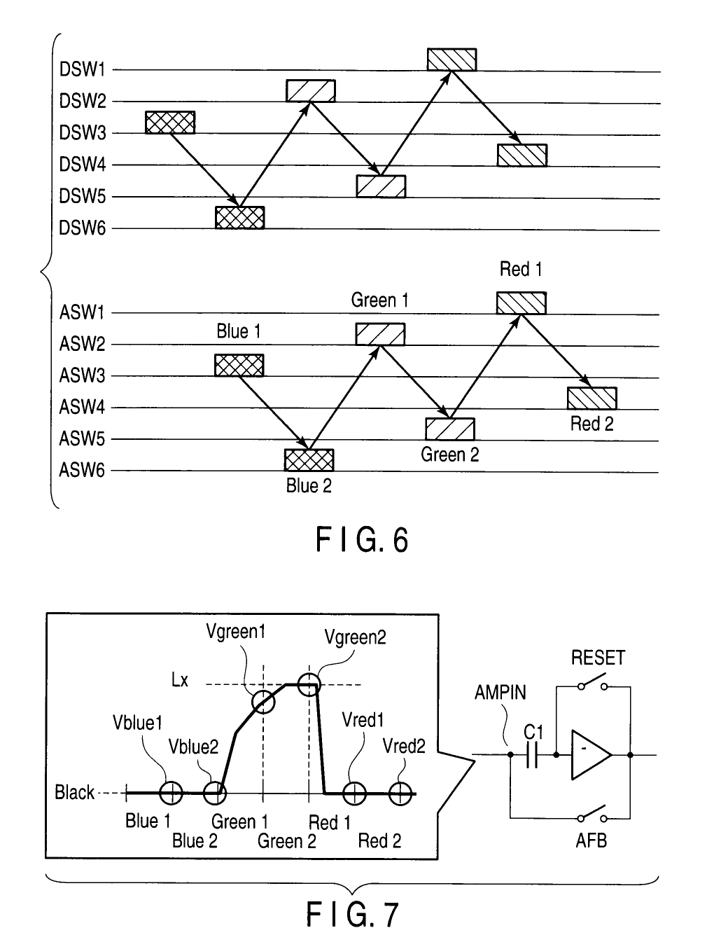

FIG. 6 is a diagram showing control timing of conventional control signals DSW1 to DSW6 and ASW1 to ASW6.

Specifically, the control timing shown in FIG. 6 is often used conventionally and shows an example in which a time-division write is performed on six source lines in order of blue 1 data (n+2), blue 2 data (n+5), green 1 data (n+1), green 2 data (n+4), red 1 data (n), and red 2 data (n+3).

FIG. 7 is a diagram showing time variation in potential at the amplifier input node AMPIN for the case of performing green raster display.

Since this is green raster display, gradation potentials Vblue1, Vblue2, Vred1, and Vred2 corresponding to blue 1, blue 2, red 1, and red 2 each have a black gradation level, as shown in the drawing.

To display a green raster at a certain gradation (e.g., gradation Lx), gradation potentials Vgreen1 and Vgreen2 for green 1 and green 2 each should essentially reach a gradation voltage Lx. However, in a write of green 1, the amount of displacement from the black gradation potential for blue 2 which is immediately therebefore is large, and thus, when the time assigned for a time-division write is short, Vgreen1 does not reach the gradation voltage Lx.

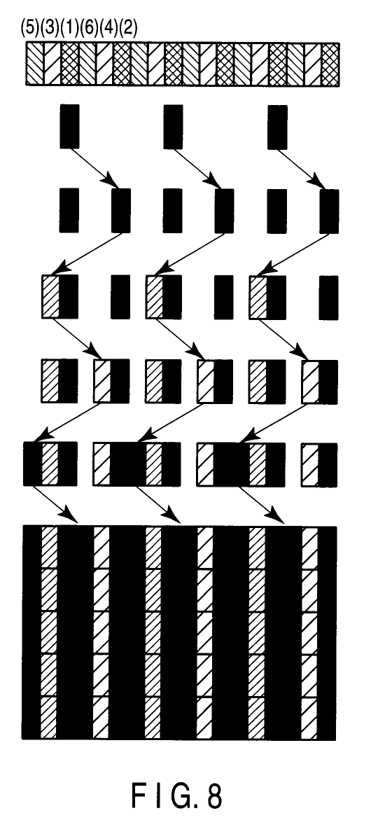

Due to this, the pixel potential for green 1 has a shortage of charge as compared with the pixel potential for green 2, and thus, a difference in luminance occurs between a green 1 pixel and a green 2 pixel. Hence, when a source line write is performed by switching signals in the above-described manner, differences in luminance are visually identified as vertical streaks, as shown in FIG. 8.

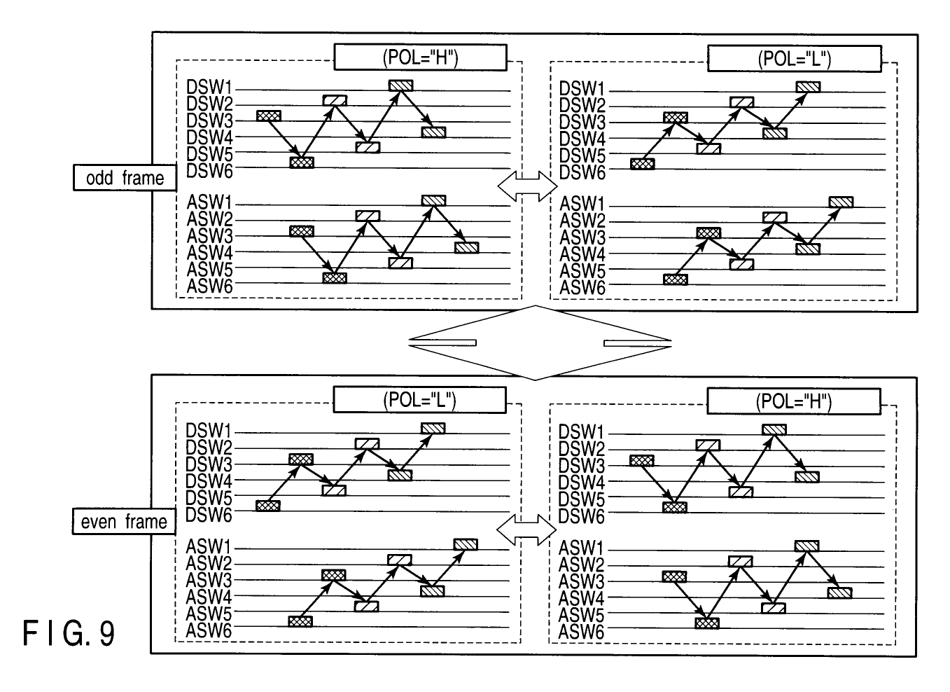

FIG. 9 is a diagram showing control timing of control signals DSW1 to DSW6 and ASW1 to ASW6 in the first embodiment of the present invention.

The time-division operation sequence of digital to analog conversion and multiplexer drive of source lines changes between colors every horizontal period and every frame.

Specifically, in odd frames, when the polarity signal POL is “H”, selection is made in order of blue 1, blue 2, green 1, green 2, red 1, and red 2 and when the polarity signal POL is “L”, selection is made in order of blue 2, blue 1, green 2, green 1, red 2, and red 1.

In even frames, when the polarity signal POL is “H”, selection is made in order of blue 2, blue 1, green 2, green 1, red 2, and red 1 and when the polarity signal POL is “L”, selection is made in order of blue 1, blue 2, green 1, green 2, red 1, and red 2.

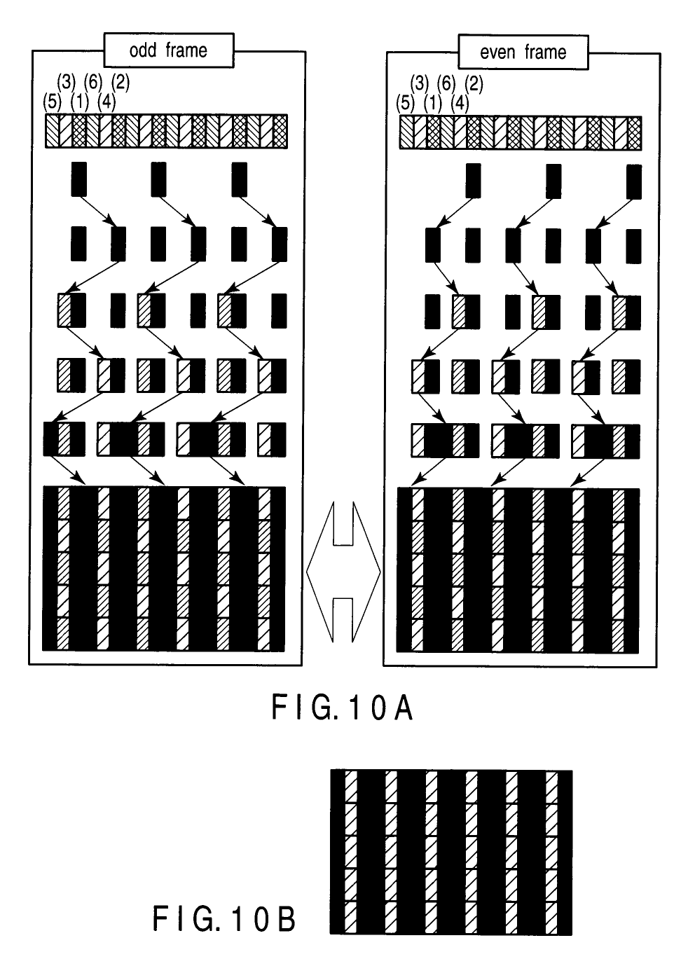

FIG. 10A is a diagram showing a state of green raster display.

Even if a shortage of charge occurs in a write of green 1, as with the conventional case, since, as described in FIG. 9, the time-division operation sequence changes every horizontal period and every frame, an address where a potential shift relative to a desired gradation voltage occurs can be two-dimensionally distributed in the plane of a display area and can be further temporally distributed every frame.

Accordingly, the potential shift relative to the desired gradation voltage is spatially and temporally averaged and thus a display image results in a green raster with uniform luminance, such as that shown in FIG. 10B.

In this manner, even when multiplexer drive of source lines and DACs are used in combination, display image quality can be improved without causing vertical streaks, non-uniformity, etc.

Also, even when the number of multiplexers is increased, degradation in display image quality can be suppressed, and thus, the circuit size can be reduced and a low-cost liquid crystal display apparatus with low power consumption and a narrow frame can be implemented.

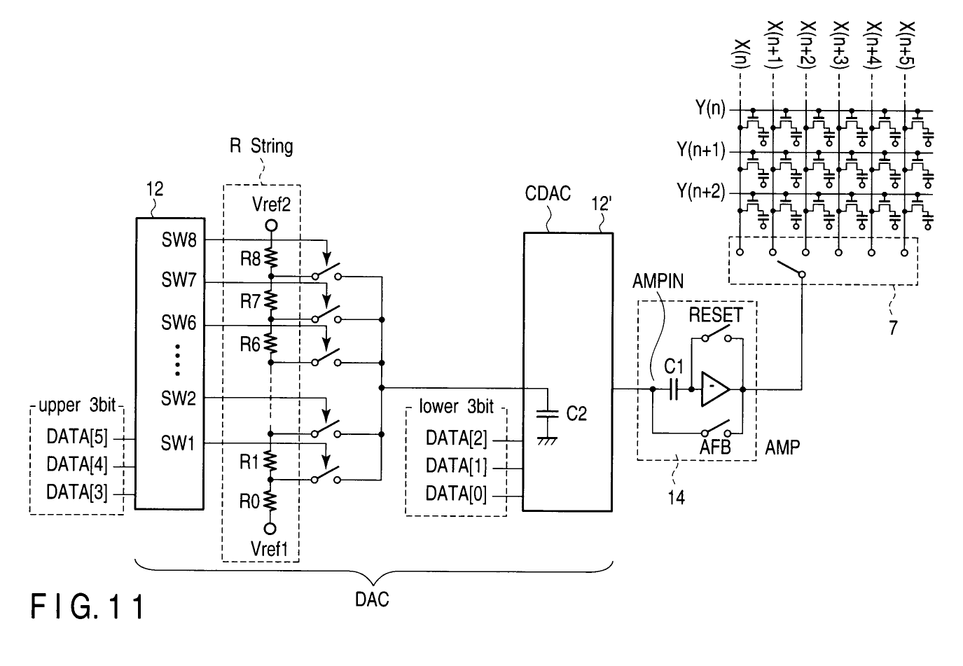

Note that the above-described first embodiment shows a configuration in which 6-bit digital data is digital to analog converted by the resistor DAC circuit 12; in the case of using a configuration, too, in which, as shown in FIG. 11, the upper three bits are digital to analog converted by the resistor DAC circuit 12 and the lower three bits are digital to analog converted by a capacitor DAC circuit 12′ (denoted as CDAC in the drawing), a charge/discharge current of an input capacitance C2 of the capacitor DAC circuit 12′ causes a voltage drop in the resistor string, and thus, the same problem occurs.

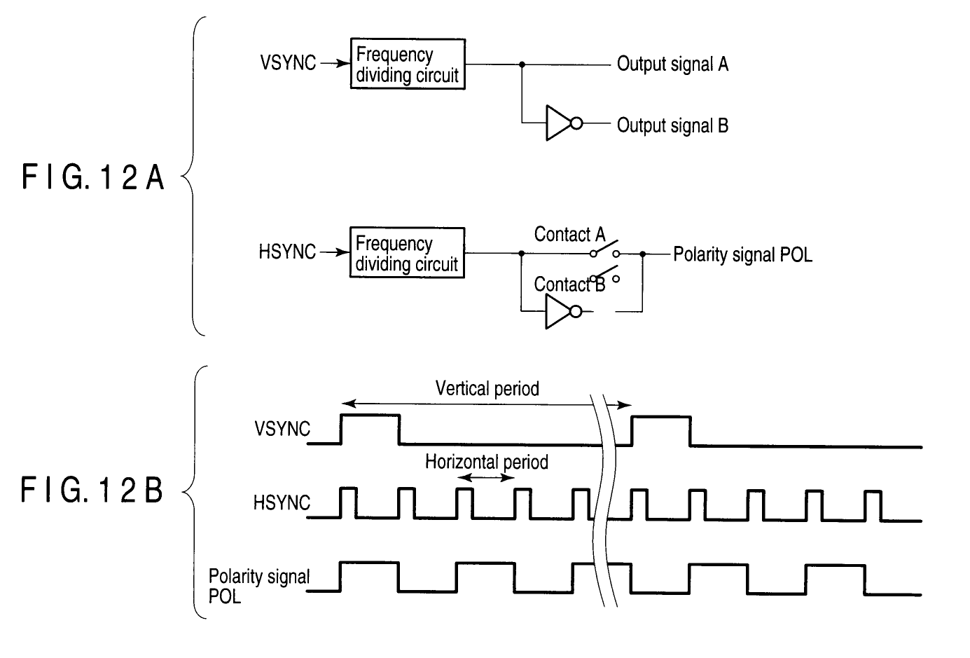

Note that a polarity signal POL can be generated by a method shown in FIGS. 12A and 12B. FIG. 12A shows a polarity signal POL generating circuit and FIG. 12B is a time chart for generating a polarity signal POL. With reference to these drawings, a method of generating a polarity signal POL will be described.

As shown in FIG. 12B, VSYNC represents a vertical synchronizing signal and is a pulse signal to be outputted every frame. HSYNC represents a horizontal synchronizing signal and is a pulse signal to be outputted every horizontal period.

As shown in FIG. 12A, VSYNC becomes, for example, a status signal whose state alternates every m vertical period, by a frequency dividing circuit. The status signal becomes an output signal A and an output signal B which are different in phase from each other, by a subsequent-stage circuit.

On the other hand, HSYNC becomes, for example, a status signal whose state alternates every n horizontal period, by a frequency dividing circuit. The phase of the status signal is controlled by the above-described output signals A and B. Specifically, when the output signal A is active, a contact A is closed and a contact B is open. Thus, an output from the frequency dividing circuit directly becomes a polarity signal POL. When the output signal B is active, the contact A is open and the contact B is closed. Thus, an output from the frequency dividing circuit is inverted and becomes a polarity signal POL.

By the above-described circuit configuration, a polarity signal POL is controlled to be a status signal whose state alternates every n horizontal period and is further controlled such that the state thereof is inverted every m vertical period. The above-described implementation example corresponds to the case in which n=1 and m=1.

Note that although in the present embodiment pixel data DO is held using the memories M and inputted to the first switcher 6, without using the memories M, data may be directly held from a data bus line.

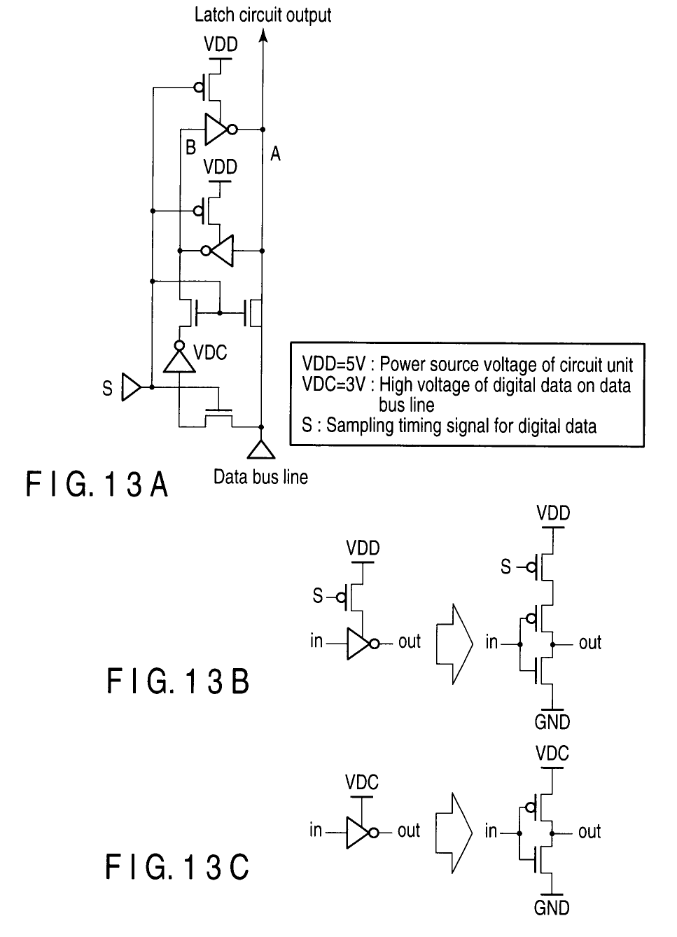

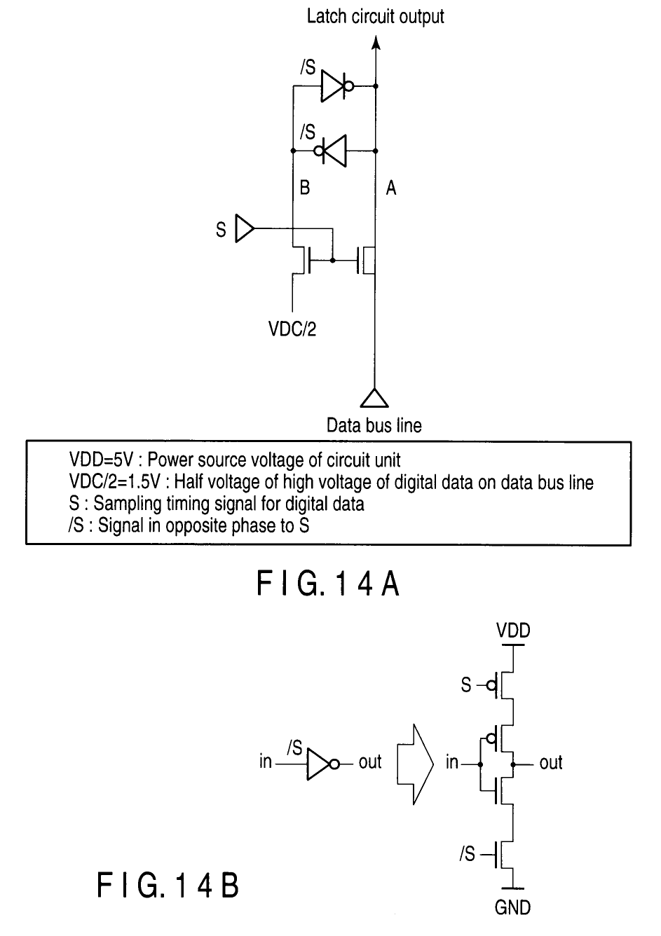

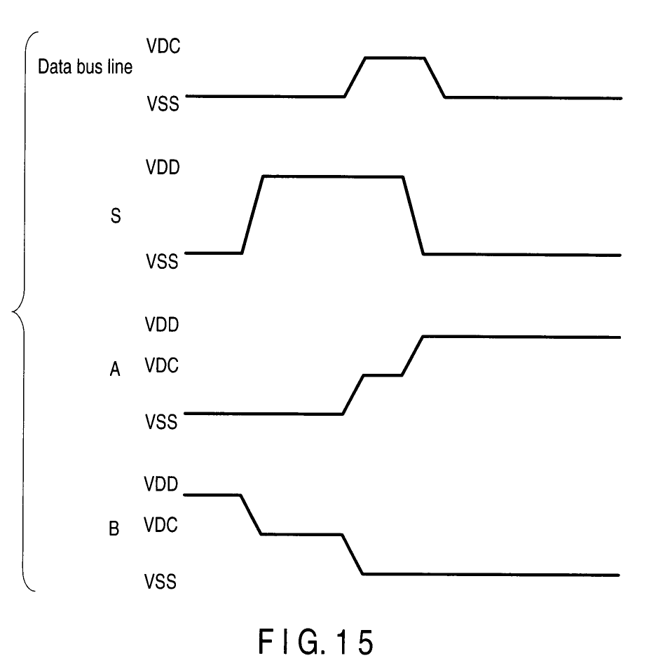

FIGS. 13A, 13B, 13C, 14A, and 14B show an exemplary circuit configuration in which data on a data bus line is latched according to a sampling timing signal S. A time chart in FIG. 15 shows an operation of holding data on the data bus line.

By thus holding data and then sequentially and selectively bringing control signals DSW1 to DSW6 into an on state by the configuration shown in FIG. 2, the data can be inputted to the digital to analog converter DAC in a time division manner.

### Second Embodiment

A second embodiment is different from the first embodiment in that groups of source lines respectively driven by amplifier circuits 14 are switched by “H” and “L” of a signal. Thus, the same parts as those in the first embodiment are denoted by the same reference numerals and a detailed description thereof is omitted.

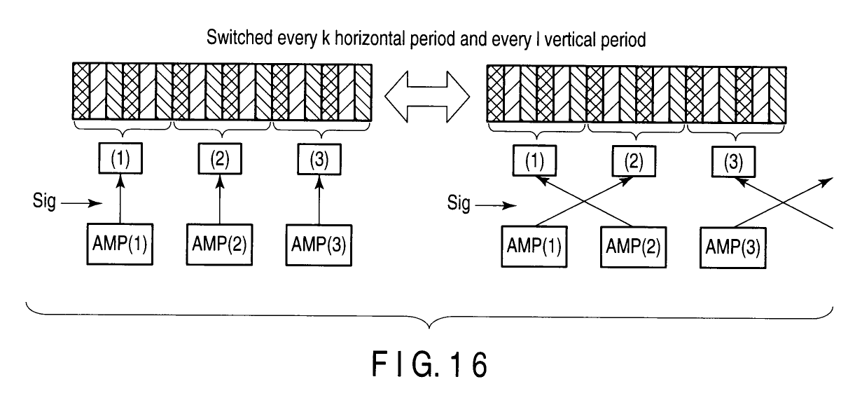

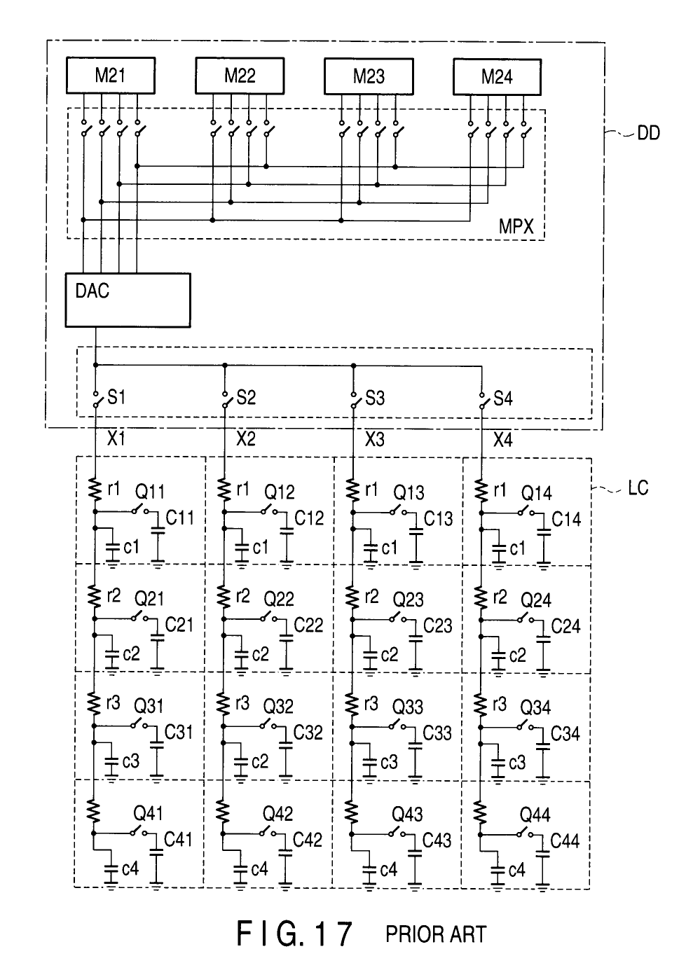

FIG. 16 is a diagram describing a method of switching between groups of source lines respectively driven by the amplifier circuits 14. FIG. 16 shows, as an example, a configuration in which one amplifier circuit 14 supplies a gradation display voltage to six source lines.

In the second embodiment, correspondences between the amplifier circuits 14 and the groups of source lines respectively driven thereby are switched every k horizontal period and further every l vertical period (k and l each are an integer greater than or equal to one). For a method for implementing this, a polarity signal POL is used as a signal and by “H” and “L” of the signal the groups of source lines respectively driven by the amplifier circuits 14 can be switched. At this time, the polarity signal POL may be held using a latch circuit shown in FIGS. 13A, 13B, 13C, 14A, and 14B and the signal may be outputted to an amplifier switching circuit (not shown), whereby a switching operation may be performed.

According to the second embodiment, even when there are variations in TFT characteristics of the amplifier circuits 14 themselves, by switching correspondences between the amplifier circuits 14 and groups of source lines respectively driven thereby, every k horizontal period and every l vertical period (k and l each are an integer greater than or equal to one), variations in write gradation display voltage are distributed and thus non-uniformity in display can be reduced.

Note that the second embodiment can also be implemented in combination with the first embodiment and can be further configured independently.

Note also that in the above-described embodiments image data is switched and outputted in a time division manner every six source lines because two source lines are targeted for each of three colors, red, green, and blue. Hence, image data may be switched and outputted in a time division manner every 3n source lines instead of six source lines. For example, image data may be switched and outputted in a time division manner every nine source lines.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A liquid crystal display apparatus comprising: a plurality of source lines and a plurality of gate lines configured to be orthogonal to one another; pixel switching elements configured to be respectively provided at intersections of the source lines and the gate lines; and a plurality of drive circuits configured to be each provided for a group of a predetermined number of source lines, and convert i (an integer greater than or equal to two)-bit data video signal into an analog gradation signal and supply the analog gradation signal to each of the source lines, the liquid crystal display apparatus performing gradation display with an ith power of 2, based on i-bit data, wherein
the drive circuits each include:
a first switching circuit which selects the video signal in a time division manner;
a digital to analog conversion circuit which converts a selected portion of the video signal into the gradation signal;
a second switching circuit which supplies the gradation signal to each source line in a time division manner; and
a control circuit which controls an order of supplying, by the second switching circuit, the gradation signal to each source line to be different every n horizontal period and every m vertical period (n and m each are an integer greater than or equal to one).

2. The liquid crystal display apparatus according to claim 1, wherein
when n=1 and m=1 and in drive in which a polarity of the gradation signal is reversed every gate line,
the control circuit controls the order of supplying the gradation signal to each source line, by a signal that controls the polarity of the gradation signal.

3. The liquid crystal display apparatus according to claim 2, wherein in the digital to analog conversion circuit, a group of source lines to which the gradation signal is supplied is different every k horizontal period and every l vertical period (k and l each are an integer greater than or equal to one).

4. The liquid crystal display apparatus according to claim 1, wherein the control circuit performs control to consecutively supply gradation signals of a same color to corresponding source lines and controls an order of supplying the gradation signals of the same color to be different every n horizontal period and every m vertical period (n and m each are an integer greater than or equal to one).

5. The liquid crystal display apparatus according to claim 4, wherein the predetermined number of source lines is six or nine.
